(19) United States
(12) Patent Application Publication
(10) Pub. No.: US 2006/0218538 A1
(43) Pub. Date: Sep. 28, 2006

(54) System, method and computer program product for converting a serialized object between different software versions

(76) Inventor: Tom A. van Kesteren, Bilthoven (NL)

Correspondence Address: SQUIRE, SANDERS & DEMPSEY L.L.P., Two Renaissance Square, Suite 2700, 40 North Central Avenue, Phoenix, AZ, 85004-4498, US

(21) Appl. No.: 11/088,259

(22) Filed: Mar. 22, 2005

(51) Int. Cl. G06F 9/45

(52) U.S. Cl. 717/137

(57) ABSTRACT

Embodiments of a system, method and computer program product for converting an object are described. In one embodiment, information is obtained from an object that identifies a first version of code associated with the object. Using the obtained information, a minimized class and converter class are identified for converting the object from a first format associated with the first version of code to a second format associated with a second version of the code. The minimized class is utilized to read the object in the first format and the converter class is utilized to convert the read object into the second format.

### TECHNICAL FIELD

Embodiments of the present invention relate generally to conversion processes and more particularly to conversion processes for object orientated applications.

### BACKGROUND

Classic programming languages generally keep data and code separated. Object Oriented (OO) languages, such as Java, tightly couple data (or “variables”) and code (or “methods”). A set of variables and related methods is called an object. In practice, objects can be of the same kind. In Java, a set of variables and methods that is common to objects of a certain kind is referred to as a class. An object created from the class is referred to as an instance of the class. As an analogy, a class may be thought of as a blueprint. Thus, a class and its related objects may be thought of as being comparable in the real world to a blueprint of a car and the cars created from the blueprint. Typically, objects may be made up of other object (e.g., the sub-components of an object may themselves comprise objects) with the relationship and arrangement of the objects composing an object (or structure of the object) being referred to as the object tree.

In order to work with objects, objects reside in a memory that is assigned for a software process. However, there is often a need to save (i.e., store) objects in a persistent medium (e.g., a hard disk or other memory device) or to exchange objects between software processes by means of an inter-process communication message. In order to be able to exchange an object between processes or to store an object on a storage medium, the object must be converted to a bit stream. The standard way of doing so in Java is by serializing it. A serialized object is available as a bit stream which can in this condition be stored on a persistent medium or communicated between processes. Converting an object to a bit stream is called serialization and converting a bit stream back to an object is called de-serialization. A serialized object is converted back to its de-serialized form when read back from the memory or when the message in the message stream arrives at the other process. A basic concept of object serialization/deserialization is the ability to write/read objects to/from a bit stream. The serialization process generally deals with flattening out an object tree such that all the raw data that makes up an object (including all of the objects referenced by that object) is saved. Then, when it is time to read back an object, the original object tree graph is recreated (i.e., de-serialization). Special cases in the object tree like circular references and multiple references to a single object may also be preserved so that when the object tree is recreated, new objects do not “magically” appear at a location where a reference to another object in the object tree should be located.

One problem arising out of serialization/de-serialization is that all classes involved in serializing an object need to be available and unchanged at de-serialization. However, this is often not the case, because software changes over time (i.e., new versions of the software are released and implemented). Thus, in practice, there may be a need to be able to serialize an object by software of a first version and de-serialize the object by software of a second version. However, in current implementations of Java, this may only be possible when there are slight or minimal changes to the involved classes. Thus, there is a need to provide a solution for this problem so that an object can be serialized by software of a first version and de- serialized by software of a second version for situations in which large or extensive changes between software versions may need to be accommodated.

### SUMMARY

Embodiments of a system, method and computer program product for converting an object are described. In one embodiment, information is obtained from an object that identifies a first version of code associated with the object. Using the obtained information, a minimized class and converter class are identified for converting the object from a first format associated with the first version of code to a second format associated with a second version of the code. The minimized class is utilized to read the object in the first format and the converter class is utilized to convert the read object into the second format.

In one embodiment, the object may comprise a serialized object. The object may be received in a bit-stream and may be stored in a persistent memory device.

Prior to de-serialization of the object, the first and second formats may be compared to identify differences therebetween. In another embodiment, the information about the object may be obtained in response to a request from an application associated with the second version of code and, after conversion using the converter class, the converted object may be provided to the requesting application.

In a further embodiment, the minimized class and/or converter class may be identified from a table. The minimized class may have the same format as the first format. In one embodiment, the object may be read utilizing a default Java method.

The minimized class includes a constructor. In one embodiment, the constructor of the minimized class may comprise a default constructor of an associated super class. In another embodiment, the constructor of the minimized class may include a call to a default constructor of an associated super class.

In even another embodiment, the converter class may have a name that indicates the identities of the first and second versions of the code. The converter class may be generated at run time and/or off-line at design time. The converter class may include instructions for converting a data element of the object such as, for example, a data structure, a primitive data element, and/or an array of data elements (including combinations thereof).

### BRIEF DESCRIPTION OF THE DRAWINGS

FIG. 1 is a schematic block diagram illustrating relationships between various data elements of a data format in accordance with an exemplary implementation;

FIG. 2 is a flowchart of an exemplary process 200 for converting an object in accordance with an embodiment of the present invention; and

FIG. 3 is a schematic diagram of a representative hardware environment in accordance with an embodiment of the present invention.

### DETAILED DESCRIPTION

In general, embodiments of the present invention may help to provide a solution for facilitating the serialization of an object by one version of software and subsequent deserializing of the object by another version of the software in a manner that may accommodate large and/or extensive changes between the software versions.

In accordance with various embodiments of the present invention, a solution for exchanging and de-serializing serialized objects between different software versions may include three phases: analyzing, generating and converting. In the analyzing phase, the differences between two software versions may be analyzed. In the generating phase, software used to deserialize serialized objects from one software version to another version is generated. In one implementation, the analyzing phase and/or generating phase may be performed before a software release is distributed (e.g., before a new version of software is released for use). The converting phase may be performed at runtime when a software process encounters an object that was serialized by a different version of the software.

### Analyzing

In the analyzing phase information is gathered about all of the classes in two software versions (e.g., an earlier version and a later version). In the analyzing phase, one task is to gather information about the data (i.e., variables) of a class as well as to gather information about methods. The collected information may be used later to create minimized classes. Minimized classes may be used when de-serializing.

The whole of all data of a class may be referred to as a data format. In the analyzing phase, information about data formats used in the two software applications that need to communicate with each other is collected and analyzed to identify the differences between the two sets of data formats of the applications.

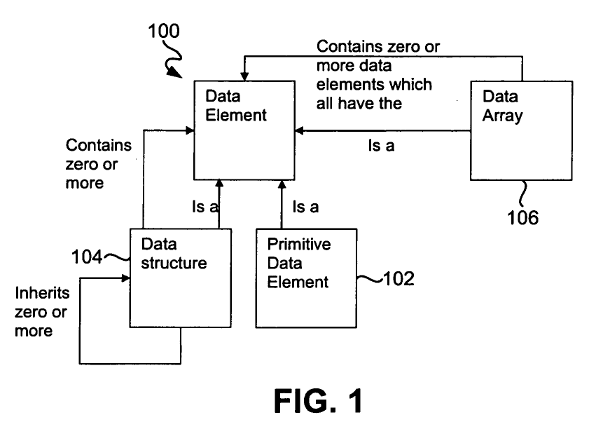

A data format (or “data type”) may comprise one or more data elements. In other words, data elements are the building blocks of data formats. There are three basic types of data elements: primitive data elements, data structures and data arrays. In accordance with an exemplary implementation, the relationships 100 between these three data elements are shown in FIG. 1. The primitive data element 102 is the simplest of the three data elements shown in FIG. 1. A primitive data element may comprise a number, text (e.g., a text string) or a Boolean operator. A data structure 104 may comprise zero or more data elements that may be primitive data elements, data structures, data arrays and/or combinations thereof. If a data structure comprises another data structure, it may inherit all of the data elements of the other data structure. A data array 106 is a list of data elements of the same type. Thus, a data array may comprise an array (or list) of primitive data elements, data structures or other data arrays. With these three data elements (and their relationships with one another) a large number of different types of data formats can be created.

Some exemplary data formats include: a MS Word document, an Adobe Portable Document Format (PDF) document, a process recipe, an event, a batch and a circle.

The following is an exemplary data format for a circle:

| Circle | | is a data structure which has: |
|---|---|---|
| | Radius | a primitive number data element; |
| | X | a primitive number data element; |
| | Y | a primitive number data element; and |
| | Shape | a data structure that inherits from another data |

| | structure comprising: |
|---|---|
| Color | a data structure comprising: |

| | |
|---|---|
| R | a primitive number data element; |
| G | a primitive number data element; and |
| B | a primitive number data element. |

In the above exemplary data format, the data structure named “Circle” is the root of this exemplary format, “number” is a specific type of primitive data element, and “R,” “G” and “B” are the names of the specific members of the data structure named “Color.

The following list presents several illustrative examples of data format changes that may occur between two versions of software:
(a) changes in the type of data element, for example:
   (i) one type of primitive data element changed to another type of primitive data element;
   (ii) a data structure changed to a primitive data element (and vice versa); and/or
   (iii) one data structure changed to another data structure;
(b) internal changes to a data structure (if a data element is a data structure then this data structure might be changed internally);
(c) change in the name of a data element;
(d) the addition of a data element to a data structure;
(e) the removal or deletion of a data element from a data structure;
(f) change in the length of an data array;
(g) where an extended relationship causes a hierarchy, change in the hierarchy of a data structure or change to one of the data structures in the hierarchy; and
(h) change in the name of a data structure type (e.g., “Circle” renamed to “CircularShape”).

Typically, object orientated languages may provide ways to shield the access to the data of a class. For example, in Java, there may typically be four different levels of access (listed in order of decreasing restriction): private, protected, default and public. In the private level of access, access is permitted to only the code for the class that contains the data. In the protected level of access, access is permitted to the code for the class that contains the data, all classes inherited from that class, and all classes in the same package. In the default level of access, access is permitted to the code for the class that contains the data and all classes in the same package. In the public level of access, access is permitted to all code of all classes.

In most cases, some level of restriction may be applicable. The code to analyze data of classes is not typically integrated with these classes and, therefore, is not normally allowed to access all data elements. One differentiating feature of Java over other languages is that a Java program can examine itself during runtime (i.e., while the Java program is running). More specifically, a Java program can ask one of its objects to identify its class, and then inspect the data elements of the identified class. In other words, the Java program can find out the names and data types of all the data elements and methods that make up the class and its super class (i.e., class that this class inherits from). This ability is referred to in Java as introspection. With introspection it may also be possible to access information about data elements that are shielded (i.e., private, default and protected data elements).

### Generating

In the generating phase, conversion software for de-serializing an object may be generated. The generated conversion software may include minimized classes and converter classes. Minimized classes may be used to de-serialize a serialized object from a bit stream (e.g., a memory file or communication message). Converter classes may be used to convert the data obtained by the minimized classes into classes of the target version of software.

### Class Name Replacement

In the past, the way to de-serialize serialized objects into the assigned memory of an application without any problems was to use the same code that serialized it. As a result, if the version of the software application that de-serializes the object was different from the software application that serialized the object, a custom-made converter needed to be built. The disadvantages of such a process were discussed above.

An important limitation in present day object orientated languages is that in a software application two or more versions of a class may not be permitted to co-exist. More specifically, classes that are different need to have different names.

With embodiments of the present invention, two versions of a class may be permitted to co-exist by the use of minimized classes and converter classes. The names of each minimized class and each converter class may include the name of the involved class as well as include a part associated with the version of the involved class (e.g., a version number of the class). In this manner, the names of the minimized classes and the converter classes are distinguished from the involved classes while their relationships with the involved classes are simultaneously expressed in their names.

### Minimized Classes

Normally, when the de-serialization code in Java finds a class name in the serialized data of an object, this code will try to find the corresponding class. In embodiments of the present invention, it is verified if there are any changes in the class. If that is the case, rather than supply Java with the class of the newer version, a minimized class is supplied instead.

Minimized classes are new classes that are based on the classes that originally serialized the object. Minimized classes may have the same data format as the original classes. However, basically all code of the original class is not included in the minimized class. The only code included in the minimized class is limited to: i) one or more required constructors; and ii) a number of empty methods that are needed to implement any unimplemented abstract methods. Information relating to the code that needs to be included in the minimized class is collected during the analyzing phase.

First, Java requires that the minimized class be provided with a correct constructor. A constructor is a method that enables the creation of an object of a given class and has the same name as the class itself. A constructor is a method of a class with no return value. Constructors also enable the initialization of any variables of a class. Input parameters can be supplied to constructors. A class may have more than one constructor. The required constructor can be a default constructor. A default constructor is a constructor which doesn't have any parameters. In case of inheritance, if the sub-class constructor does not explicitly call the super class constructor, Java will call the super class default constructor. If the super class does not have default constructor, the minimized class may need to be provided with a constructor method of its own. This constructor can be a simple one that simply calls one of the constructors of the super class for example.

Second, method information may need to be collected during the analyzing phase because the super class can have some methods or inherited methods that are abstract and not implemented by the super class. In order to create an object from a class, the class may need to have all abstract methods implemented. So, if the super class of a minimized class has remaining unimplemented abstract methods, then the minimized class may need to have implementations of those unimplemented abstract methods. For each unimplemented abstract method, an empty method may be generated. An empty method is a method with a minimum of code and serves to generate an implementation of an unimplemented abstract method.

While it may be possible to copy just those classes that have changed between software versions and simply rename the changed classes in order to allow them to coexist with the newer versions, renaming may require an enormous number of extra classes which in turn could lead to a large increase in the memory footprint and would slow down the conversion process. This problem could arise due to the fact that not only can the data of a class comprise references to other classes but also, code of the classes may comprise references to the code of other classes, which in turn can comprise further references, so on. As a consequence, code dependencies may be much more complex than just the dependencies described by the data portion of a class. Thus, using minimized classes may help to reduce the amount of extra classes needed for conversion and thereby may help to simplify and speed-up the conversion process.

In one embodiment, only classes that have been changed directly or indirectly need to be converted to minimized classes. Classes that remain unchanged between two versions of software do not need to be minimized and can remain untouched. Such unchanged classes may be referred to as normal classes. A minimized class may also inherit from a normal class.

### Converter Classes

A converter class may be created for each concrete class that has changed. A concrete class is a class that has no unimplemented abstract methods. The name of a converter class may be composed of the name of the class involved and the two software versions involved. The converter class may contain code that converts between the two data format sets of the difference software versions. Because the data formats are known, these conversion procedures are also known. In one embodiment, the converter class code may be generated during run time.

In another embodiment, the converter class code may be generated off-line at design time. In such an embodiment, static software may be generated that spells out each conversion step. Data formats that are different may then be presented to the user with the corresponding generated conversion software. The user may then validate the correctness of the generated conversion software. The use may also be permitted to filter out data formats for which conversion is unwanted or unnecessary (for instance, because the user knows that a given data format(s) is not actually implemented or utilized). As another option, a user may be permitted apply custom conversion steps as needed. However, since the conversion software is substantially generated automatically minimal user interaction is typically needed.

As previously mentioned, the building block of all data formats is a data element. A data element can be a data structure, a primitive data element, an array of data elements or any combination thereof. If data is to be converted from one format to another, then the way of converting may depend on the type of the root data element: For example, the type of the Target Data element may be made equal to the type of the root data element of the Source data format using a process conforming to the following exemplary pseudo code:
Iterate:
IF data element is a data structure THEN
   Check if a converter class exists for this data structure
   IF a converter class exits for the data structure THEN
      Use the converter class to create data with a new format
   REPEAT “Iterate” procedure for each data element in the data structure including inherited data elements
IF data element is a primitive data element THEN
   Convert primitive data element according to primitive data element conversion rules //(see e.g., Table 1)//
IF data element is an array THEN
   IF data elements in this array are data structures THEN
      Create a new array comprising data structures in the new format REPEAT “Iterate” procedure for each data element of the array
   IF data elements in array are primitive data elements THEN
      Convert according to the primitive data element conversion rules //(see e.g., Table 1)//
   IF data elements in array are arrays THEN
      REPEAT “Iterate” procedure for each sub array

As references in the pseudo code above, Table 1 provides an exemplary set of conversion rules for a primitive data element.

TABLE 1

| Converting | Converting To: | | |
|---|---|---|---|
| From: | Text | Number | Boolean |
| Text | Copy. | Parse if possible, | Parse if possible, |
| | | otherwise set to | otherwise set to |
| | | default number value. | default Boolean value. |
| Number | Convert | Copy. | If number = 0, then |
| | to text. | | false, otherwise true. |
| Boolean | Convert | Convert to number | Copy. |
| | to text. | where: | |
| | | False = 0, and | |
| | | True = 1. | |

### Converting

In accordance with one embodiment, serialized objects may be marked with a software release version to permit determination at runtime whether a serialized object needs to be converted from one software version to another software version. De-serialization may then be performed as follows. The software release version may then be compared with the version of the software performing the de-serialization. A table of compatible versions may be used to determine whether conversion between the two versions is possible. If it is determined that conversion is possible or necessary, minimized classes may be used to read the serialized object from memory/bit stream using a default Java method. Converter classes may then be used to convert the data of these minimized classes into classes of the specific target class version involved. The converted object may then be passed to the application software that requested the de-serialization. With this process, the requesting application software need not be unaware of any conversions.

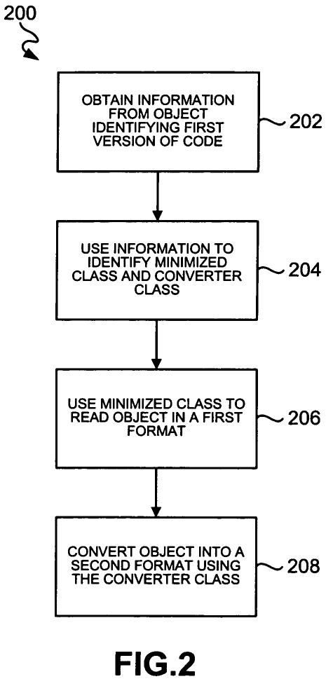

FIG. 2 is a flowchart of an exemplary process 200 for converting an object in accordance with an embodiment of the present invention. In operation 202, information is obtained from an object that identifies a first version of computer code associated with the object. The object may comprise a serialized object that is serialized according to the first data format. The object may be received in a bit-stream and/or may be stored in a persistent memory device.

In operation 204 of the process 200, the information about the first version of computer code obtained from the object may be utilized to identify a minimized class and converter class for converting the object from a first data format associated with the first version of the computer code (e.g., the data format of a class in the first version of the computer code) to a second data format associated with a second version of the computer code (e.g., the data format of a class in the second version of the computer code). A table of compatible versions may be utilized to indicate whether an object may be converted from the first version of computer code to the second version of computer code. In one embodiment, the minimized class and converter class may be identified from the table of compatible versions utilizing the information obtained from the object.

With continuing reference to FIG. 2, the object in the first data format is read utilizing the minimized class associated with the first version of computer code in operation 206. The minimized class may be based on the class of the object in the first version of computer code. In one embodiment, a minimized class may have a class name that contains information that identifies (or indicates the identity of) the first version of the computer code. In another embodiment, the name of a minimized class may include information about a named class associated with both the first and second versions of computer code.

The object may be read utilizing a default Java method. In one embodiment, the minimized class may have the same data format as the first data format of the class of the object in the first version of the computer code. The minimized class may also include a constructor. In such an embodiment, the constructor of the minimized class may comprise a default constructor of an associated super class. In another embodiment, the constructor of the minimized class may include a call to a default constructor of an associated supper class. In a further embodiment, the minimized class may have an implementation of an unimplemented abstract method of an associated super class.

With further reference to FIG. 2, the converter class is utilized to convert the read object into the second data format associated with the second version of the computer code in operation 208. The converter class includes code for carrying out the conversion from the first data format to the second data format. For example, the converter class may include instructions for converting a data element of the object such as a data structure, a primitive data element and/or an array of data elements. The converter class may have a name that indicates the identities of the first and second versions of the computer code. The converter class may be generated at run time and/or off-line.

In one embodiment, the information about the object may be obtained (see operation 202) in response to a request from an application associated with the second version of computer code. In such an embodiment, the converted object resulting from operation 208 may be provided to the requesting application. In another embodiment, the first and second data formats may be compared to identify any differences therebetween prior to serialization of the object and/or the obtaining of information in operation 202.

### Newer and Older Software Versions

A version of software always has a release date. In the following we will assume that versions of software are always sequentially released and that for two versions always one version can be identified as being older than the other one. Obviously, the software of the older version can not be aware of any changes with respect to any newer versions. When an object needs to be transferred between two software applications of different versions, two different situations can exist: the object needs to be transferred from the newer version to the older version or it needs to be transferred from the older version to the newer version. The newer version application needs to transfer the object to the older version in the minimized class format. The only requirement that is posed on the older version application is that it has knowledge of the minimized class naming convention so that it is able replace the name of the minimized class by the class name of the older version. As an example we consider a class “Recipe” existing in older version 1 and newer version 2 and that this class has changed in content but not in name.

We will first consider the situation that an object is transferred from the older version 1 application to the newer version 2 software application. Version 1 application has serialized the class Recipe and transfers it to application version 2. First, version 2 applies class name replacement to change the name of the class from “Recipe” into “V1 Recipe” which is the name of the minimized Recipe class of version 1. Then the Java de-serialization code creates an object of the “V1.Recipe” class. This object is then converted by the convert method of a converter class called “V1.Recipe_to_V2”. This converter is basically suitable to convert any kind of object to any other kind of object, but it is used in our application to convert an object of a class defined in one version into an object of the same class defined in another version. The result of the conversion is an object of class “Recipe” of software version 2.

We will now consider the situation that an object is transferred from newer software application version 2 to older software application version 1. The communication protocol will exchange the software version information when establishing the communication. This allows each software version to act accordingly. The older version cannot handle an object of a newer version. Therefore, software version 2 first converts the Recipe object of version 2 into an object of the minimized class “V1.Recipe” by using the convert method of a converter class called “Recipe_To_V1”. The result is an object of class “V1.Recipe”. This object is serialized and transferred to software version 1 which identifies that the class is a minimized class because it has a “V1” in front of the “Recipe” class name. This “V1” is then removed using class name replacement after which the standard Java code is used to de-serialize the object to an object of the type “Recipe” of software version 1.

### Representative Hardware Environment

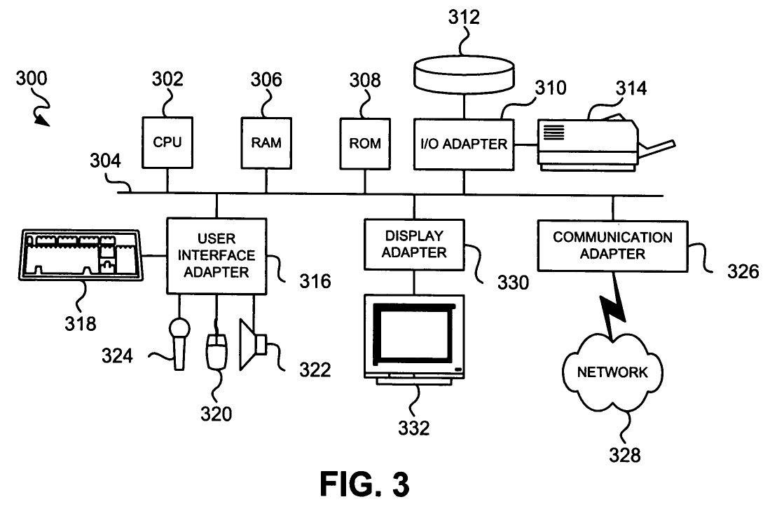

A representative hardware environment that may be utilized for implementing various embodiments of the present invention is depicted in FIG. 3. In the present description, the various sub-components of each of the components may also be considered components of the system. For example, particular software modules executed on any component of the system may also be considered components of the system. In particular, FIG. 3 illustrates an exemplary hardware configuration of a workstation 300 having a central processing unit 302, such as a microprocessor, and a number of other units interconnected via a system bus 304.

The workstation shown in FIG. 3 includes a Random Access Memory (RAM) 306, Read Only Memory (ROM) 308, an I/O adapter 310 for connecting peripheral devices such as, for example, disk storage units 312 and printers 314 to the bus 304, a user interface adapter 316 for connecting various user interface devices such as, for example, a keyboard 318, a mouse 320, a speaker 322, a microphone 324, and/or other user interface devices such as a touch screen or a digital camera to the bus 304, a communication adapter 326 for connecting the workstation 300 to a communication network 328 (e.g., a data processing network) and a display adapter 330 for connecting the bus 304 to a display device 332. The workstation may utilize an operating system such as the Microsoft Windows NT or Windows/95 Operating System (OS), the IBM OS/2 operating system, the MAC OS, or UNIX operating system. Those of ordinary skill in the art will appreciate that the present invention may also be implemented on platforms and operating systems other than those mentioned.

An embodiment of the present invention may also be written using Java, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:
Objects can represent physical objects, such as automobiles in a traffic-flow simulation, electrical components in a circuit-design program, countries in an economics model, or aircraft in an air-traffic-control system.
Objects can represent elements of the computer-user environment such as windows, menus or graphics objects.
An object can represent an inventory, such as a personnel file or a table of the latitudes and longitudes of cities.
An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

Some benefits of object classes can be summarized, as follows:
Objects and their corresponding classes break down complex programming problems into many smaller, simpler problems.
Encapsulation enforces data abstraction through the organization of data into small, independent objects that can communicate with each other. Encapsulation protects the data in an object from accidental damage, but allows other objects to interact with that data by calling the object's member functions and structures.
Subclassing and inheritance make it possible to extend and modify objects through deriving new kinds of objects from the standard classes available in the system. Thus, new capabilities are created without having to start from scratch.
Polymorphism and multiple inheritance make it possible for different programmers to mix and match characteristics of many different classes and create specialized objects that can still work with related objects in predictable ways.
Class hierarchies and containment hierarchies provide a flexible mechanism for modeling real-world objects and the relationships among them.
Libraries of reusable classes are useful in many situations, but they also have some limitations. For example:
Complexity. In a complex system, the class hierarchies for related classes can become extremely confusing, with many dozens or even hundreds of classes.
Flow of control. A program written with the aid of class libraries is still responsible for the flow of control (i.e., it must control the interactions among all the objects created from a particular library). The programmer has to decide which functions to call at what times for which kinds of objects.
Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:
Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.
Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.
Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Sun Microsystems defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

JavaScript is an interpreted programming or script language from Netscape. It is somewhat similar in capability to Microsoft's Visual Basic, Sun's Tcl, the UNIX-derived Perl, and IBM's REX. In general, script languages are easier and faster to code in than the more structured and compiled languages such as C and C++. JavaScript is used in Web site development to do such things as: automatically change a formatted date on a Web page; cause a linked-to page to appear in a popup window; and cause text or a graphic image to change during a mouse rollover.

JavaScript uses some of the same ideas found in Java. JavaScript code can be imbedded in HTML pages and interpreted by the Web browser (or client). JavaScript can also be run at the server as in Microsoft's Active Server Pages before the page is sent to the requester. Both Microsoft and Netscape browsers support JavaScript.

Another technology that provides similar function to Java is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for Java without undue experimentation to practice the invention.

A technology of Active X is the component object model (COM). Used in a network with a directory and additional support, COM becomes the distributed component object model (DCOM). The main thing that you create when writing a program to run in the ActiveX environment is a component, a self-sufficient program that can be run anywhere in your ActiveX network. This component is known as an ActiveX control. ActiveX is Microsoft's answer to the Java technology from Sun Microsystems. An ActiveX control is roughly equivalent to a Java applet. OCX stands for “Object Linking and Embedding control.” Object Linking and Embedding (OLE) was Microsoft's program technology for supporting compound documents such as the Windows desktop. The Component Object Model now takes in OLE as part of a larger concept. Microsoft now uses the term “ActiveX control” instead of “OCX” for the component object. An advantage of a component is that it can be re-used by many applications (referred to as component containers). A COM component object (ActiveX control) can be created using one of several languages or development tools, including C++ and Visual Basic, or PowerBuilder, or with scripting tools such as VBScript.

Serialization involves saving the current state of an object to a stream, and restoring an equivalent object from that stream. The stream functions as a container for the object. Its contents include a partial representation of the object's internal structure, including variable types, names, and values. The container may be transient (RAM-based) or persistent (disk-based). A transient container may be used to prepare an object for transmission from one computer to another. A persistent container, such as a file on disk, allows storage of the object after the current session is finished. In both cases the information stored in the container can later be used to construct an equivalent object containing the same data as the original. The example code in this article will focus on persistence.

Inheritance may be defined as a relationship that defines one entity in terms of another. Class inheritance defines a new class in terms of one or more parent classes. The new class may inherit its interface and implementation from its parent class(es). The new class is called a subclass or a derived class. Class inheritance may combine interface inheritance and implementation inheritance. Interface inheritance defines a new interface in terms of one or more existing interfaces while implementation inheritance defines a new implementation in terms of one or more existing implementations. In object-oriented programming, inheritance may further be defined as an ability to create new classes (or interfaces) that contain all the methods and properties of another class (or interface), plus additional methods and properties. For example, if class (or interface) “B” inherits from class (or interface) “A”, then class B is said to be derived from class A. Class B may be referred to as a base (or super) class (or interface) for class D. When a class of objects is defined, any subclass that is defined may inherit the definition of one or more general classes. In the case where some modification to the definition is needed in the subclass, new methods and/or properties may be included in the definition.

A bit stream may be defined as a continuous transfer of bits over some medium. For example, a bit stream may comprise a series of transmitted bits through a transmission link.

A superclass (as referred to as a base or parent class) is one from which other classes are derived using inheritance. In class inheritance, the subclass is said to inherit its interface and implementation from its superclass(es). In object orientated programming, a superclass may be a class that is above another class in the class hierarchy. For example, class “A” may be a superclass of class “B” if classes A and B are on the same branch of a class hierarchy tree and class A is higher on that branch than class B.

In general, introspection may comprise the ability of an object to reveal information about itself as an object such as for example, the object's class, superclass), the messages the object is capable of responding to, and the protocols to which the object conforms. In Java, introspection may further comprise a process by which a class is read in order to create a representation of the object's application program interface (API). Introspection may be carried out by the Java Introspector class, which is part of the Java Core Reflection API. Introspection may be used to provide additional information about an object, supplementing information learned by reflection.

Run-time may be defined as a time during which a program is active and being executed or executing (i.e., the time the program is being run).

Design time may be defined as a time during which an application is being built in a development environment/process. Code may be created and edited during design time.

Transmission Control Protocol/Internet Protocol (TCP/IP) is a basic communication language or protocol of the Internet. It can also be used as a communications protocol in the private networks called intranet and in extranet. TCP/IP is a two-layering program. The higher layer, Transmission Control Protocol or TCP, manages the assembling of a message or file into smaller packet that are transmitted over the Internet and received by a TCP layer that reassembles the packets into the original message. The lower layer, Internet Protocol or IP, handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.). Several higher layer application protocols use TCP/IP to get to the Internet. These include the World Wide Web's Hypertext Transfer Protocol (HTTP), the File Transfer Protocol (FTP), Telnet, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does). Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

Based on the foregoing specification, the invention may be implemented using computer programming or engineering techniques including computer software, firmware, hardware or any combination or subset thereof. Any such resulting program, having computer- readable code means, may be embodied or provided within one or more computer-readable media, thereby making a computer program product, i.e., an article of manufacture, according to the invention. The computer readable media may be, for instance, a fixed (hard) drive, diskette, optical disk, magnetic tape, semiconductor memory such as read-only memory (ROM), etc., or any transmitting/receiving medium such as the Internet or other communication network or link. The article of manufacture containing the computer code may be made and/or used by executing the code directly from one medium, by copying the code from one medium to another medium, or by transmitting the code over a network.

One skilled in the art of computer science will easily be able to combine the software created as described with appropriate general purpose or special purpose computer hardware to create a computer system or computer sub-system embodying the method of the invention.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed:

1. A method for converting an object, comprising:
obtaining information from an object that identifies a first version of code associated with the object;
identifying, using the obtained information, a minimized class and converter class for converting the object from a first format associated with the first version of code to a second format associated with a second version of the code;
reading the object in the first format utilizing the minimized class associated with the first version of code; and
converting the read object into the second format associated with the second version of code utilizing the converter class.

2. The method of claim 1, wherein the object comprises a serialized object.

3. The method of claim 1, wherein the object is received in a bit-stream.

4. The method of claim 1, wherein the object is stored in a persistent memory device.

5. The method of claim 1, wherein the information about the object is obtained in response to a request from an application associated with the second version of code.

6. The method of claim 5, wherein the converted object is provided to the requesting application.

7. The method of claim 1, wherein the first and second formats are compared to identify differences therebetween prior to the obtaining.

8. The method of claim 1, wherein the minimized class and converter class are identified from a table.

9. The method of claim 1, wherein the minimized class has the same format as the first format.

10. The method of claim 1, wherein the object is read utilizing a default Java method.

11. The method of claim 1, wherein the minimized class includes a constructor.

12. The method of claim 11, wherein the constructor of the minimized class comprises a default constructor of an associated super class.

13. The method of claim 11, wherein the constructor of the minimized class includes a call to a default constructor of an associated supper class.

14. The method of claim 1, wherein the converter class has a name indicating the identities of the first and second versions of the code.

15. The method of claim 1, wherein the converter class is generated at run time.

16. The method claim 1, wherein the converter class is generated off-line.

17. The method of claim 1, wherein the converter class includes instructions for converting a data element of the object.

18. The method of claim 17, wherein the data element comprises at least one of a data structure, a primitive data element and an array of data elements.

19. A system for converting an object, comprising:
logic for obtaining information from an object that identifies a first version of code associated with the object;
logic for identifying, using the obtained information, a minimized class and converter class for converting the object from a first format associated with the first version of code to a second format associated with a second version of the code;
logic for reading the object in the first format utilizing the minimized class associated with the first version of code; and
logic for converting the read object into the second format associated with the second version of code utilizing the converter class.

20. A computer program product for converting an object, comprising:
computer code for obtaining information from an object that identifies a first version of code associated with the object;
computer code for identifying, using the obtained information, a minimized class and converter class for converting the object from a first format associated with the first version of code to a second format associated with a second version of the code;
computer code for reading the object in the first format utilizing the minimized class associated with the first version of code; and
computer code for converting the read object into the second format associated with the second version of code utilizing the converter class.
